(19) United States
(12) Patent Application Publication
(10) Pub. No.: US 2003/0080241 A1
(43) Pub. Date: May 1, 2003

(54) Air launch of payload carrying vehicle from a transport aircraft

(76) Inventors: Daniel Shpigler, Haifa (IL); Ronen Sher, Shimshit (IL); Ephraim Bashan, Yavne (IL); Yoram Ilan-Lipovsky, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/256,249

(22) Filed: Sep. 26, 2002

(30) Foreign Application Priority Data
Sep. 30, 2001 (IL) 145708

(51) Int. Cl. B64C 37/02; B64D 5/00

(52) U.S. Cl. 244/2

(57) ABSTRACT

An aircraft carrier adapted to carry and release a carried store for air launch purposes. The aircraft carrier includes a carrying station coupled to a part of the aircraft carrier and being a priori adapted to carry a load other than the carried store to be launched. The carried store to be launched is mountable to a coupling device that is mountable to the carrying station. The aircraft carrier also includes a control system capable of communicating with the coupling device for selectively releasing the carried store.

### FIELD OF THE INVENTION

The present invention relates generally to Airborne Space Launching Systems and, more particularly, to Airborne Space Launching Systems, which are, suitable to be carried under the wing of a civilian transport aircraft.

### REFERENCES

[1] “MIL-STD-1763A: Aircraft/Stores Certification Procedures”—December 1990.

[2] “MIL-STD-A-8591H: Airborne store, suspension equipment and aircraft-store interface (carriage phase); General design criteria for”—December 1983.

### BACKGROUND OF THE INVENTION

Consumer demand for smaller and cost effective satellites is growing stronger, both from commercial and government-funded users. From the manufacturer's standpoint, this calls for an effort to achieve development and product cost reduction.

One known method of reducing the dimensions of the payload-carrying vehicle, and hence reducing its cost, is based on the concept of an airborne launched vehicle (also known as “air launch”). This concept includes the deployment of the payload-carrying vehicle (PCV) from a carrying aircraft at desired geographic location and flight conditions. After being launched, the PCV propels itself (with the payload, say a satellite, onboard) into orbit.

The air launch concept has several advantages over traditional ground launches, including: the initial altitude and airspeed of the PCV are that of the carrying aircraft and the flight path does not cross the low atmosphere, thus minimizing drag and gravity losses.

Additional, yet different kinds of advantages lie with the ability to fly to a wide range of launch sites on the globe, according to the required mission. Furthermore, airborne launch can be performed at any direction, including directly to the desired orbit direction, and it is possible to fly above bad weather with the carrying aircraft. Many countries, which suffer from geographic restrictions upon their ability to launch a vehicle into space, may use air launch to overcome these restrictions.

Ground launch systems are subjected to operational geographical restrictions in order to avoid flight over populated or unfriendly areas. In some cases, the restrictions may impose severe performance penalties.

An air launch system known to use the advantages mentioned above is the “Pegasus” airborne launch system (see U.S. Pat. No. 4,901,949, to Elias), thus enabling to carry a payload approximately twice of a similar sized ground launched vehicle.

The Pegasus system manufactured by “Orbital Sciences” Corporation has been especially designed as an airborne system. Pegasus has a solid-propellant booster with wings. Pegasus is launched from under the fuselage of a specially modified Lockheed L—1010 carrier aircraft.

A different approach of utilizing airborne launch is the “piggy-back” carrying of the PCV atop the fuselage of an aircraft. This approach is much more complex because of the unusual carrying technique.

Another approach of airborne launch includes a PCV carried inside the aircraft. In order to safely release the PCV from the aircraft, a parachute or a different device must be utilized.

A different approach, (see e.g. U.S. Pat. No. 6,029,928, to Kelly), makes use of a glider as the PCV, connected via cable to the aircraft. This technique may improve performance, but special attachment and release mechanisms must be developed.

Even with the advantages of the airborne launch concept, the cost of developing such PCV could be enormous. The cost includes development of the PCV itself and the cost of modifying a special carrying aircraft for the mission. All these costs increase the cost of each launch.

Another problem relates to the need of integrating the PCV with the carrying aircraft. One major concern is the requirement of safe distance between the PCV and the aircraft fuselage. For example, the need to clear the landing gear doors on the carrying aircraft may impose modifications on the PCV itself. Usually, these kinds of problems are avoided by carrying the PCV under the wing. An under-the-fuselage carriage has advantages of strength and stiffness.

There is thus a need in the art to substantially reduce the limitations of hitherto known techniques for air launch and in particular, to minimize modifications that are required in the carrying aircraft, thereby substantially reducing the manufacturing and launching costs involved in an air launch.

### SUMMARY OF THE INVENTION

The technique of the invention offers the reduction of the development cost, as well as the cost per launch, and is particularly applicable to small satellite-launchers that can be carried under an aircraft wing. Hence, the method relates typically, although not necessarily, to small satellites, (commonly known as “micro” satellites).

The method presented herein makes use of the aircraft carrying-weight limitations, authorized by the aircraft manufacturer, with substantially no additional structural changes.

The reduction of the aircraft modifications in accordance with an embodiment of the invention is accomplished by carrying the PCV under the wing, using an already existing station. This also means that any other aircraft, with a suitable carrying installation, could be considered as a suitable candidate to launch a PCV. It should be noted that the latter is only an example and other kinds of carried store are applicable.

Moreover, it should be further appreciated that the carried store may be coupled to a station associated with a part of the aircraft, e.g., beneath the fuselage.

Some passenger and cargo aircraft have a built-in installation under the wing, (e.g., the Boeing 747, with a special station under its left wing), which is used to carry a fifth engine for transportation purposes. This wing carrying-station can be utilized for carrying other types of external stores (PCV for example). The wing-station can be used with only limited changes to the aircraft, e.g., adjusting the engine-pylon to fit its new mission and pertinent changes in the controls (e.g. electric control) in the carried store release system. Hence, the adjustment of a civilian transport aircraft for carrying and releasing an external store, can be cost-effectively achieved. It should be noted that releasing encompasses inter alia free dropping, pivot assisted dropping, jettison or ejection.

As long as store dimensions and weight are within the existing limits (which vary from one aircraft to another and could be obtained from the aircraft manufacturer) or very close to them, the task of proving the safety of the new aircraft configuration, is much simpler. By the specific example of Boeing 747, the carrying limitations are those authorized by the aircraft manufacturer, for carrying a fifth engine at a specific wing station.

Still, the procedure for getting the needed verifications must be completed. Remaining tasks are much less extensive compared to the redesign of a new wing or body station, as is the case with the hitherto known systems. Store separation analysis must be conducted to ensure successful launch. The procedures needed to get aircraft/store certification are described in detail in [1]. For example, one of the steps dedicated by these procedures is the certification analysis. This analysis is carried out prior to any flight with the store and it results with a release envelope, meaning, the flight conditions (i.e., aircraft height and velocity) for a safe release of the store away from the aircraft.

Accordingly, the present invention provides for an aircraft carrier adapted to carry and release at least one carried store for air launch purposes, comprising:

a carrying station associated with a part of the aircraft carrier and being a priori adapted to carry load other than said at least one carried store;

the at least one carried store being mountable to a coupling device that is mountable to said station;

a control system capable of communicating with said coupling device for selectively releasing said carried store.

The invention further provides for use with the aircraft carrier of the kind specified, at least one carried store being mountable to a coupling device that is mountable to said station.

### BRIEF DESCRIPTION OF THE DRAWINGS

For a better understanding, the invention will now be described by way of example only with reference to the accompanying drawings, in which:

FIG. 1 illustrates schematically an aircraft carrier carrying an airborne payload carrying vehicle (PCV) in accordance with an embodiment of the invention;

FIG. 2a illustrates schematically how the PCV is mounted beneath the wing in accordance with an embodiment of the invention;

FIG. 2b illustrates in more detail how the PCV is mounted beneath the wing in accordance with an embodiment of the invention; and

FIG. 3 illustrates a typical flight path of the PCV from launch to orbit;

### DETAILED DESCRIPTION OF THE INVENTION

In accordance with an embodiment of the present invention there is provided a way of reducing the adjusting costs of a civilian transport aircraft for a new mission: the carriage of an external store under its wing, and the release of this store. This is achieved by a new use of an existing wing-station installation, used, in the specific case of Boeing 747 for carrying a fifth engine. Even with this new use, the certified limitations of the existing wing-station, as authorized by the aircraft manufacture, should not be violated.

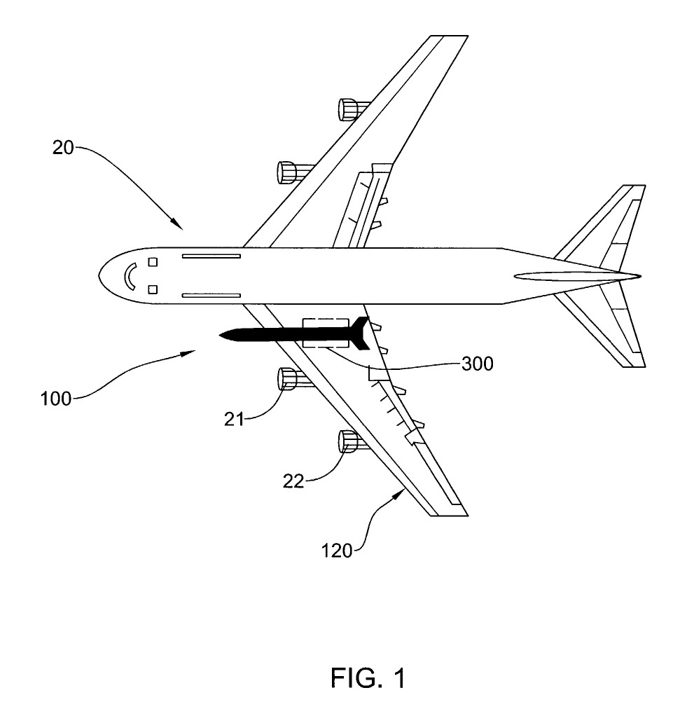

One embodiment of the invention is shown in FIG. 1, which is an io illustration of aircraft 20 carrying an airborne Payload Carrying Vehicle (PCV—being one form of a carried store), generally designated 100. The vehicle 100 is mounted under the wing 120 of aircraft 20 by means of a coupling device, e.g., pylon 300. The latter is located under the aircraft wing, inboard of the aircraft engines 21 and 22.

Note that the location of the existing station is not bound to beneath the wing, and depending on the carrying aircraft it can be located in other locations, say beneath the fuselage.

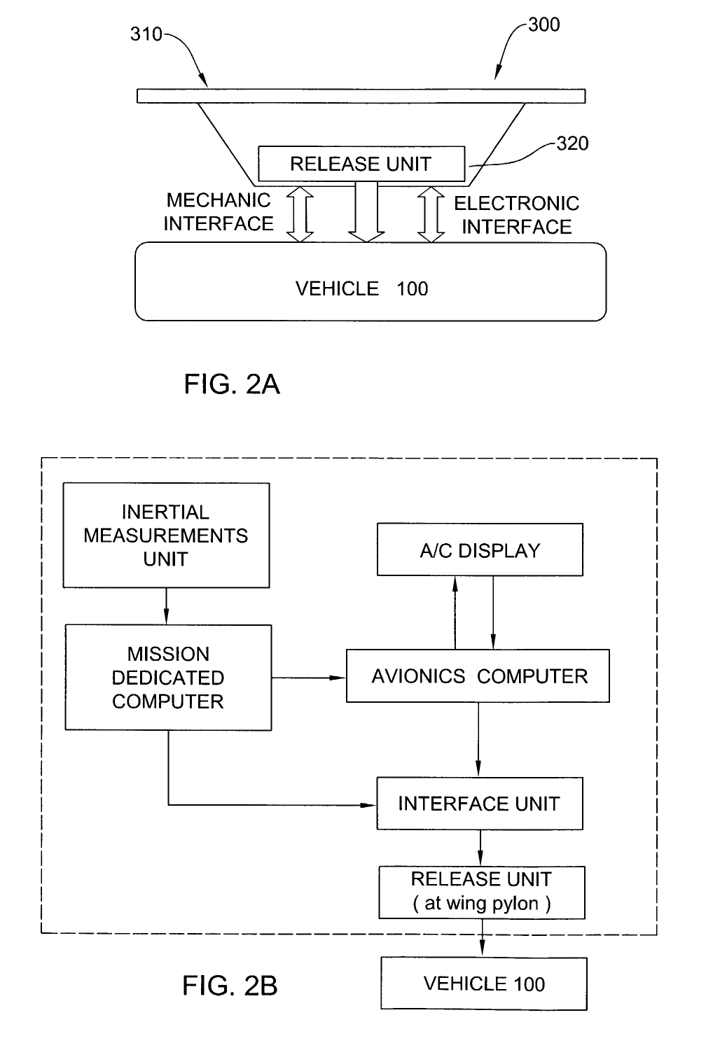

Attention is now drawn to FIG. 2A, illustrating schematically how the vehicle is mounted to the wing. As shown, pylon 300 is mounted under the aircraft wing 310. A release unit, denoted as 320, is mounted inside the pylon. The interface of the vehicle 100 with the aircraft includes mechanical and electronic interfaces. Vehicle 100 can be mounted to the pylon through a known per se coupling interface, e.g. via common suspension lugs, as described in detail in [2], or, according to another embodiment, the coupling means can be a special designed mechanism, according to its specific characteristics, all as required and appropriate.

A more detailed block diagram of the interface between vehicle 100 and the aircraft systems is shown in FIG. 2-B. The aircraft systems that relate with this interface comprise several units. A brief description of their main characteristics is as follows:

Aircraft display—the relevant information is displayed to the system operator.

Avionics computer—this computer controls the PVC system. Its main tasks include signal processing and delivering commands to the interface unit, to and from the aircraft display.

Mission dedicated computer—this computer is used mainly to carry out navigation and the mission specific calculations.

Interface unit—this unit includes communication lines.

Release unit—this unit usually lies within an aircraft pylon, with or without ejection unit. The PCV is attached to the release unit.

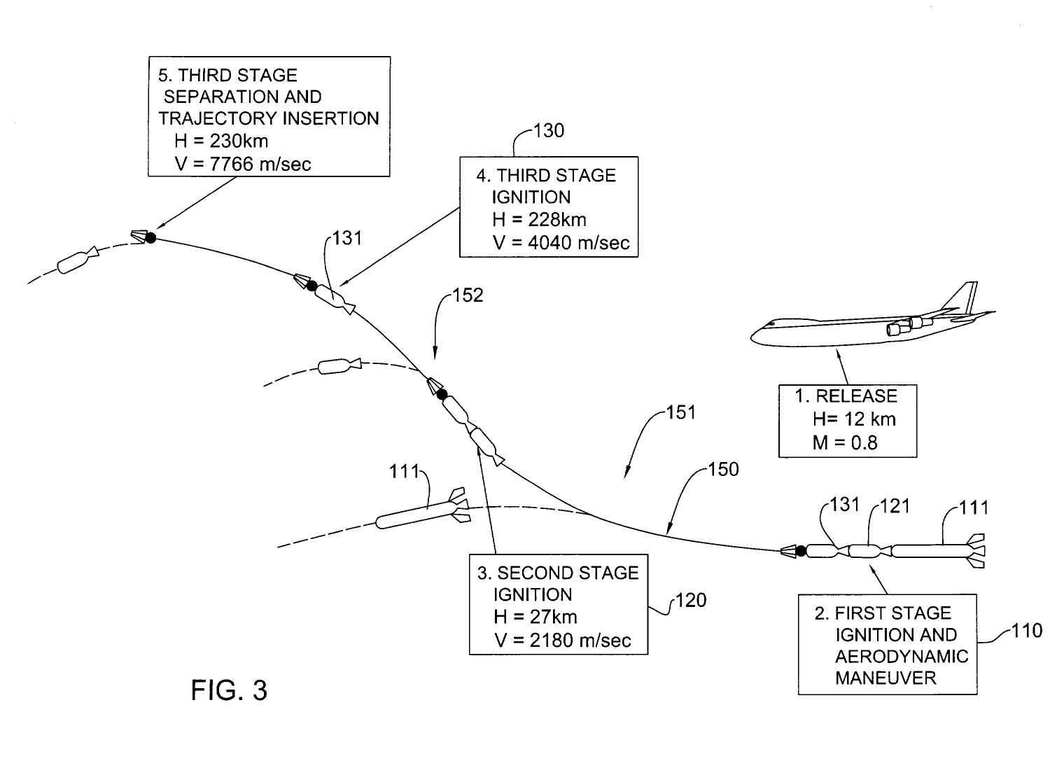

There follows now a description of a typical sequence of operation of an air launching (from launch to orbit) in accordance with one embodiment of the invention. Thus, Vehicle 100, typically although not necessarily, is an air-launched vehicle equipped with steering fins, used as PCV to deliver a payload, say small satellites into orbit. By this embodiment (shown in FIG. 3), the PCV includes a first stage 110, second stage 120 and third stage 130, having first, second and third stage solid propellant motors, 111, 121 and 131, respectively. In another embodiment of the invention, the PCV includes another fourth stage, mainly aimed at modifying orbit parameters.

It should be noted that the type of the payload and the number of engines is determined depending upon the nature of the mission.

A typical flight path of vehicle 100 is shown schematically in FIG. 3. The vehicle is released from the carrying aircraft under the control of an electronic release control system, (similar to a control system of conventional dropped payload). The vehicle has an initial velocity equal to the aircraft velocity of say, M=0.8 at height 12 km. The initial weight of the vehicle, in this example, is approximately 6000 kg. The first engine is ignited only after the vehicle is safely cleared away from the aircraft (say, 6 second after release). The PCV is maneuvered to a desired angle of attack so as to follow a predetermined flight path (150).

Each powered phase is used to gain more energy, increasing the vehicle velocity and height. After each burnout, the empty-used engine is dropped. After the burnout of the second engine (152), a ballistic flight is utilized, until vehicle 100 reaches a desired height. At the shown example, this height is 228 km. At this height, (130), the third engine (131) is ignited and an additional speed is gained. At the third burnout, vehicle 100 has reached a velocity of 7766 m/s, which is velocity needed to keep a circular orbit at a height of 230 km. Note that by this example the satellite weighs approximately 116 kg, however, those versed in the art may readily appreciate that this weight may vary according to the specific mission (i.e., due to a change of orbit inclination and launch conditions).

In another embodiment of the invention, vehicle 100 is any other carried store, thus its payload and path can be significantly different from the example given herein.

The present invention eliminates many of the modifications that otherwise (i.e., in accordance with hitherto known systems) are needed. In particular, when the PCV characteristics (weight, dimensions, etc.) are within the known certified limits, the verification process should not be complicated. Thus, for example, in the Boeing 747, it has a built-in installation under its left wing, which is planned to carry a fifth engine for transportation purposes. This wing carrying-station can be utilized for carrying other types of external stores, including PCV. This use of the wing-station can be implemented substantially without making any structural changes to the aircraft.

The present invention has been described with a certain degree of particularity, but those versed in the art will readily appreciate that various alterations and modifications can be carried out without departing from the scope of the following claims.

1. An aircraft carrier adapted to carry and release at least one carried store for air launch purposes, comprising:
a carrying station associated with a part of the aircraft carrier and being a priori adapted to carry a load other than said at least one carried store;
the at least one carried store being mountable to a coupling device that is mountable to said station;
a control system capable of communicating with said coupling device for selectively releasing said carried store.

2. The aircraft carrier according to claim 1, wherein said carried store being a payload carrying vehicle (PCV) that includes a payload on board.

3. The aircraft carrier according to claim 2, wherein said payload being a micro satellite.

4. The aircraft carrier according to claim 3, wherein said coupling device includes a pylon.

5. The aircraft carrier according to claim 4, wherein said part being the aircraft carrier wing.

6. The aircraft carrier according to claim 5, wherein said aircraft carrier is a Boeing 747 aircraft fitted with four engines, and said station is located beneath one of the wings of the Boeing 747, and is a priori adapted to carry a fifth engine.

7. A Boeing 747 aircraft fitted with four engines, adapted to carry and release at least one carried store for air launch purposes, comprising:
a carrying station located beneath one of the wings of the Boeing 747 and being a priori adapted to carry a fifth engine;
the at least one carried store being mountable to a coupling device that is mountable to said station;
a control system capable of communicating with said coupling device for selectively releasing said carried store.

8. The aircraft carrier according to claim 7, wherein said carried store is a payload carrying vehicle (PCV) that includes a payload on board.

9. The aircraft carrier according to claim 8, wherein said payload is a micro satellite.

10. The aircraft carrier according to claim 9, wherein said coupling device includes a pylon.

11. A coupling device mountable to a carrying station of an aircraft carrier for carrying and releasing at least one carried store mountable thereon; said carrying station associated with a part of the aircraft carrier and being a priori adapted to carry a load other than said at least one carried store; and said coupling device is connectable to a control system for selectively releasing said carried store.

12. The coupling device according to claim 11, wherein said carried store is a payload carrying vehicle (PCV) that includes a payload on board.

13. The coupling device according to claim 12, wherein said payload is a micro satellite.

14. The coupling device according to claim 11, wherein said coupling device includes a pylon.

15. The coupling device according to claim 11, wherein said part is the aircraft carrier wing.

16. The aircraft carrier according to claim 11, wherein said aircraft carrier is a Boeing 747 aircraft fitted with four engines, said station being located beneath one of the wings of the Boeing 747 and a priori adapted to carry a fifth engine.

17. A coupling device mountable to a carrying station of a Boeing 747 aircraft fitted with four engines, for carrying and releasing at least one carried store mountable thereon; said station being located beneath one of the wings of a Boeing 747 and a priori adapted to carry a fifth engine; said coupling device being connectable to a control system for selectively releasing said carried store.

18. The coupling device according to claim 17, wherein said carried store is a payload carrying vehicle (PCV) that includes a payload on board.

19. The coupling device according to claim 18, wherein said payload is a micro satellite.

20. The coupling device according to claim 17, wherein said coupling device includes a pylon.
